(19) United States
(12) Patent Application Publication
(10) Pub. No.: US 2026/0269127 A1
(43) Pub. Date: Sep. 10, 2026

(54) MULTILAYER ELECTRONIC COMPONENT

(71) Applicant: SAMSUNG ELECTRO-MECHANICS CO., LTD., Suwon-si (KR)

(72) Inventors: Hye Jin Jeong, Suwon-si (KR); Ji Seop Oh, Suwon-si (KR); Je Hee Lee, Suwon-si (KR); Dong Jun Jung, Suwon-si (KR); Hyun Kim, Suwon-si (KR); Ji Hyun Lee, Suwon-si (KR)

(73) Assignee: SAMSUNG ELECTRO-MECHANICS CO., LTD., Suwon-si (KR)

(21) Appl. No.: 19/443,795

(22) Filed: Jan. 8, 2026

(30) Foreign Application Priority Data
Mar. 6, 2025 (KR) 10-2025-0028574

(51) Int. Cl. H01G 4/12; H01G 4/232; H01G 4/30

(52) U.S. Cl. CPC H01G 4/1227; H01G 4/232; H01G 4/30

(57) ABSTRACT

A multilayer electronic component according to an embodiment of the present disclosure includes a dielectric layer, the dielectric layer comprises core-shell grains and rare-earth elements. The central region of the core includes a first core and second core. The maximum strains of the crystal lattice a-axis lattice constants of the second core in Eaa directions, with respect to the crystal lattice a-axis lattice constants in the central region of the first core, are defined as ba1 and ba2, respectively. The maximum strains of the crystal lattice c-axis lattice constant of the second core in Ecc directions, with respect to the crystal lattice c-axis lattice constant in the central region of the first core, are defined as bc1 and bc2, respectively. At least three of the ba1, ba2, bc1 and bc2 values may satisfy 0.5% to 1.5%.

### CROSS-REFERENCE TO RELATED APPLICATION(S)

This application claims benefit of priority to Korean Patent Application No. 10-2025-0028574 filed on Mar. 6, 2025 in the Korean Intellectual Property Office, the disclosure of which is incorporated herein by reference in its entirety.

### TECHNICAL FIELD

The present disclosure relates to a multilayer electronic component.

### BACKGROUND ART

A multilayer ceramic capacitor (MLCC), a multilayer electronic component, is a chip-type condenser, mounted on the printed circuit boards of various types of electronic products, such as image display devices including a liquid crystal display LCD and a plasma display panel PDP, computers, smartphones and mobile phones, and serves to charge or discharge electricity therein or therefrom.

Such multilayer ceramic capacitors may be used as a component in various electronic devices due to having a small size, ensuring high capacitance and being easily mounted. As various electronic devices, such as computers and mobile devices, or the like, become smaller and have higher output, demand for miniaturization and high capacitance of multilayer ceramic capacitors is increasing.

As multilayer ceramic capacitors become smaller, designs simultaneously satisfying reliability and capacity are required. In order to ensure reliability in a thin dielectric layer, the grain size must be reduced to increase the grain boundary area; however, in this case, it may be difficult to secure sufficient capacitance. Accordingly, design studies are being conducted on base materials with enhanced reliability and dielectric characteristics.

Meanwhile, one factor that may increase the permittivity of barium titanate (BaTiO₃)-based dielectric materials is stress control within a core-shell structure. When compressive stress is applied within the core, the dielectric characteristics may be deteriorated, whereas when tensile stress is applied within the core, the dielectric characteristics may be improved. However, if excessive tensile stress is applied within the core, there is a risk that the dielectric characteristics may deteriorate due to distortion of the crystal lattice, so a design of the base material that may apply appropriate tensile stress within the core is required.

### DISCLOSURE OF INVENTION

### Technical Problem

One of many problems to be solved by the present disclosure is to provide a multilayer electronic component having enhanced reliability.

One of many problems to be solved by the present disclosure is to provide a multilayer electronic component having enhanced dielectric characteristics.

One of many problems to be solved by the present disclosure is to provide a multilayer electronic component comprising core-shell grains having a region in which tensile stress is applied internally without inducing line defects such as dislocations.

One of many problems to be solved by the present disclosure is to provide a dielectric material having a lattice constant ratio (c/a) having enhanced tetragonality.

However, the many problems to be solved by the present disclosure are not limited to the above and will be more easily understood in the process of describing specific embodiments of the present disclosure.

### Solution to Problem

A multilayer electronic component according to an embodiment of the present disclosure may comprise: a body including dielectric layers and internal electrodes; and external electrodes disposed on the body, wherein the dielectric layers may include core-shell grains having a core and a shell surrounding at least a portion of the core, the shell including a rare-earth element, wherein a central region of the core is referred to as a first core, and a region surrounding at least a portion of the first core is referred to as a second core, wherein maximum strains of crystal lattice a-axis lattice constants of the second core in both Eaa directions, with respect to crystal lattice a-axis lattice constants in the central region of the first core, are defined as ba1 and ba2, respectively, wherein maximum strains of crystal lattice c-axis lattice constants of the second core in both Ecc directions, with respect to crystal lattice c-axis lattice constants in the central region of the first core, are defined as bc1 and bc2, respectively, and wherein at least three of the ba1, ba2, bc1 and bc2 values may satisfy +0.5% or greater and +1.5% or less.

According to another embodiment of the present disclosure, a dielectric composition comprises core-shell grains having a core and a shell surrounding at least a portion of the core, the shell including a rare-earth element, wherein a central region of the core is referred to as a first core, and the region surrounding at least a portion of the first core is referred to as a second core, wherein maximum strains of crystal lattice a-axis lattice constants of the second core in both Eaa directions, with respect to crystal lattice a-axis lattice constants in the central region of the first core, are defined as ba1 and ba2, respectively, wherein maximum strains of crystal lattice c-axis lattice constants of the second core in both Ecc directions, with respect to crystal lattice c-axis lattice constants in the central region of the first core, are defined as bc1 and bc2, respectively, and wherein at least three of the ba1, ba2, bc1 and bc2 values may satisfy +0.5% or greater and +1.5% or less.

### Advantageous Effects of Invention

One of many effects of the present disclosure is to improve a reliability of a multilayer electronic component.

One of many effects of the present disclosure is to improve dielectric characteristics of a multilayer electronic component.

One of many effects of the present disclosure is to improve a lattice constant ratio (c/a) of the dielectric material.

However, the various advantageous effects of the present disclosure are not limited to the above and will be more easily understood in the process of describing specific embodiments of the present disclosure.

### BRIEF DESCRIPTION OF DRAWINGS

FIG. 1 schematically illustrates a perspective view of a multilayer electronic component according to an embodiment of the present disclosure.

FIG. 2 schematically illustrates a cross-sectional view taken along line I-I′ of FIG. 1.

FIG. 3 schematically illustrates a cross-sectional view taken along line II-II′ of FIG. 1.

FIG. 4 schematically illustrates core-shell grains included in a dielectric layer.

FIG. 5A is an image of the core-shell grains of an example observed using a high-resolution transmission electron microscope (HRTEM), FIG. 5B is a strain mapping image in the Eaa direction of FIG. 5A, FIG. 5C is a deformation mapping image in the Ecc direction of FIG. 5A, and FIG. 5D illustrates a strain graph by region of FIG. 5B, and FIG. 5E illustrates a region-by-region deformation graph of FIG. 5C.

FIG. 6A is an image of the core-shell grains of a comparative example observed using a high-resolution transmission electron microscope (HRTEM), FIG. 6B is a strain mapping image in the Eaa direction of FIG. 6A, FIG. 6C is a deformation mapping image in the Ecc direction of FIG. 6A, FIG. 6D illustrates the strain graph by region of FIG. 6B, and FIG. 6E illustrates the strain graph by region of FIG. 6C.

FIG. 7A is an image of the core-shell grains of the example observed using a high-resolution transmission electron microscope (HRTEM), FIG. 7B is a fast Fourier transform (FFT) of FIG. 7A, and FIG. 7C is a graph illustrating the lattice constant ratio (c/a) based on the analysis of FIG. 7B. FIG. 7D is an image of the core-shell grains of the comparative example observed using a high-resolution transmission electron microscope (HRTEM), FIG. 7E is a fast Fourier transform (FFT) of FIG. 7D, and FIG. 7F is a graph illustrating the lattice constant ratio (c/a) based on the analysis of FIG. 7E.

### DESCRIPTION OF REFERENCE CHARACTERS

Hereinafter, embodiments of the present disclosure will be described with reference to specific embodiments and the accompanying drawings. However, embodiments of the present disclosure may be modified to have various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

Here and throughout the specification and claims, range limitations are combined and/or interchanged. Such ranges are identified and include all the sub-ranges contained therein unless context or language indicates otherwise. For example, all ranges disclosed herein are inclusive of the endpoints, and the endpoints are independently combinable with each other.

Approximating language, as used herein throughout the specification and claims, may be applied to modify any quantitative representation that could permissibly vary without resulting in a change in the basic function to which it is related. Accordingly, a value solidified by a term or terms, such as “about”, and “substantially” is not to be limited to the precise value specified.

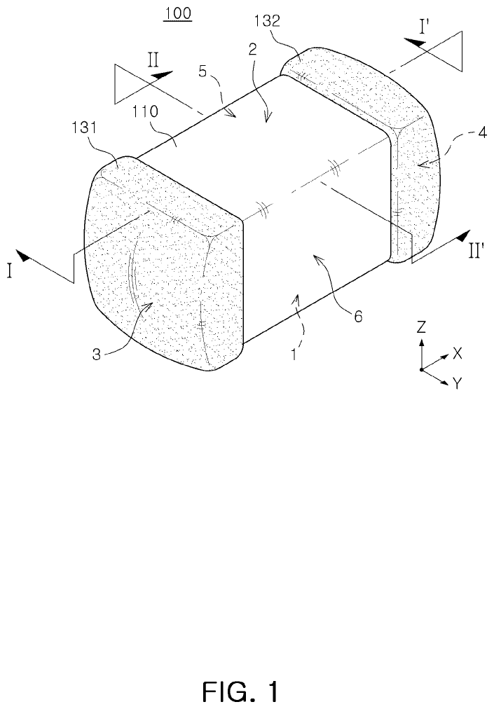

FIG. 1 schematically illustrates a perspective view of a multilayer electronic component according to an embodiment of the present disclosure.

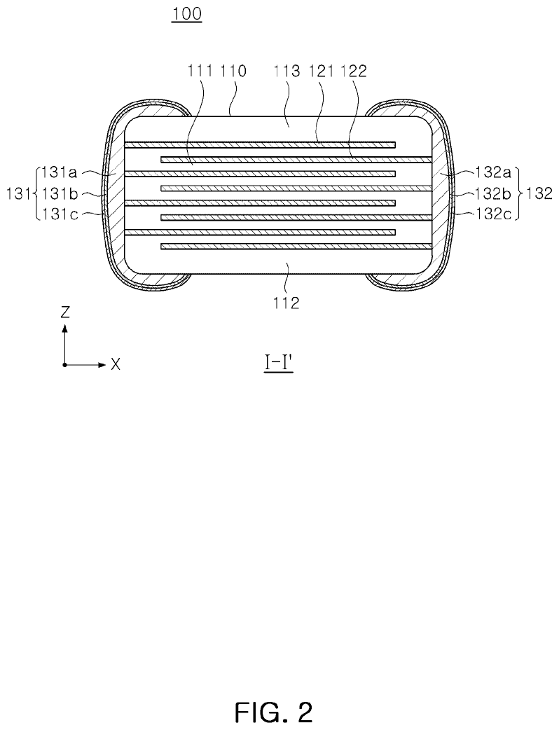

FIG. 2 schematically illustrates a cross-sectional view taken along line I-I′ of FIG. 1.

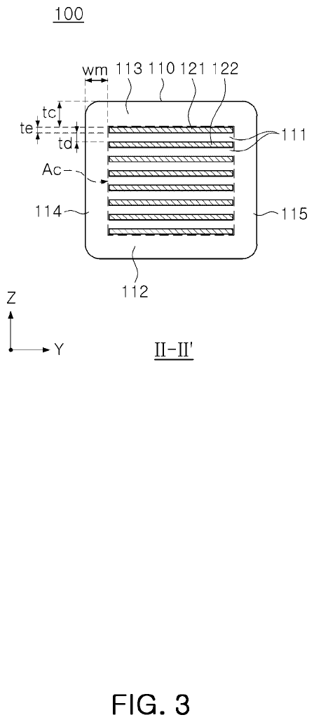

FIG. 3 schematically illustrates a cross-sectional view taken along line II-II′ of FIG. 1.

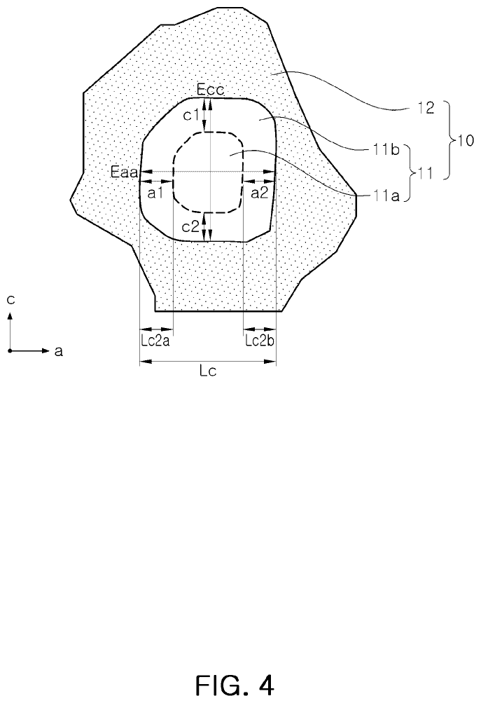

FIG. 4 schematically illustrates core-shell grains included in a dielectric layer.

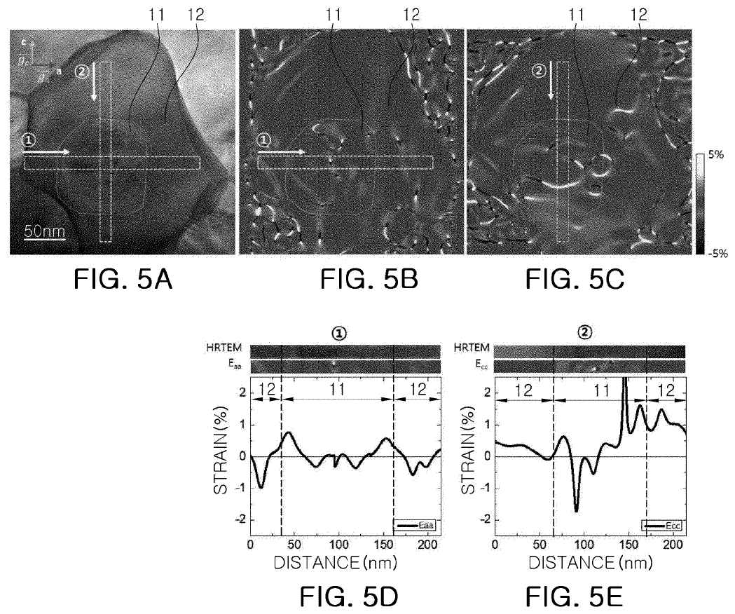

FIG. 5A is an image of the core-shell grains of an example observed using a high-resolution transmission electron microscope (HRTEM), FIG. 5B is a strain mapping image in the Eaa direction of FIG. 5A, FIG. 5C is a deformation mapping image in the Ecc direction of FIG. 5A, and FIG. 5D illustrates a strain graph by region of FIG. 5B, and FIG. 5E illustrates a region-by-region deformation graph of FIG. 5C.

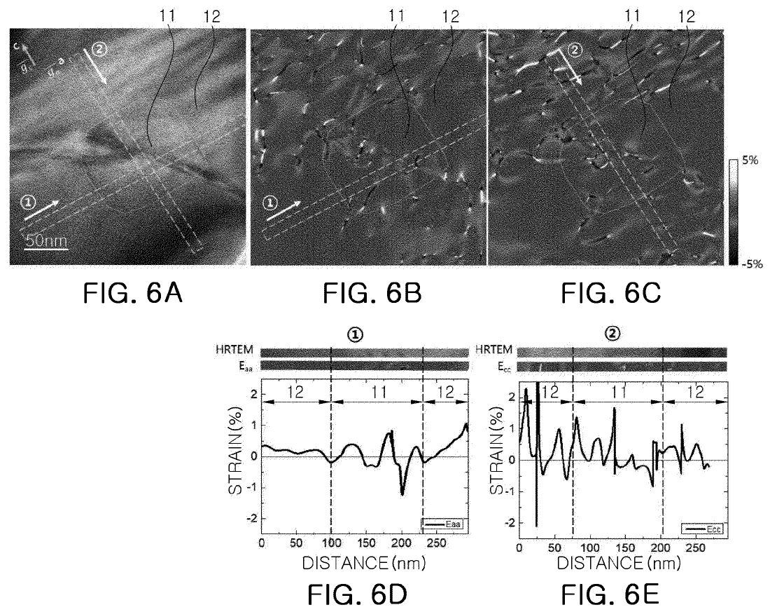

FIG. 6A is an image of the core-shell grains of a comparative example observed using a high-resolution transmission electron microscope (HRTEM), FIG. 6B is a strain mapping image in the Eaa direction of FIG. 6A, FIG. 6C is a deformation mapping image in the Ecc direction of FIG. 6A, FIG. 6D illustrates the strain graph by region of FIG. 6B, and

FIG. 6E illustrates the strain graph by region of FIG. 6C.

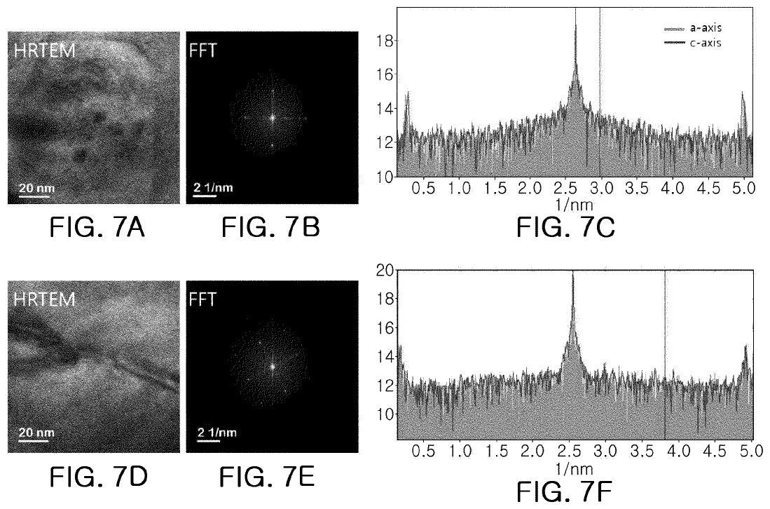

FIG. 7A is an image of the core-shell grains of the example observed using a high-resolution transmission electron microscope (HRTEM), FIG. 7B is a fast Fourier transform (FFT) of FIG. 7A, and FIG. 7C is a graph illustrating the lattice constant ratio (c/a) based on the analysis of FIG. 7B. FIG. 7D is an image of the core-shell grains of the comparative example observed using a high-resolution transmission electron microscope (HRTEM), FIG. 7E is a fast Fourier transform (FFT) of FIG. 7D, and FIG. 7F is a graph illustrating the lattice constant ratio (c/a) based on the analysis of FIG. 7E.

In the drawings, a Z-direction may be defined as a thickness direction or a first direction, an X-direction as a length direction or a second direction, and a Y-direction as a width direction or a third direction.

Additionally, a stacking direction may be a thickness direction or a width direction.

Hereinafter, with reference to FIGS. 1 to 7E, a multilayer electronic component and/or dielectric composition according to an embodiment of the present disclosure will be described in detail. As an example of a multilayer electronic component, a multilayer ceramic capacitor is described, but the present disclosure may also be applied to various electronic products using a dielectric composition, such as inductors, piezoelectric elements, varistors, or thermistors.

A multilayer electronic component 100 according to an embodiment of the present disclosure may comprise a body 110 and external electrodes 131 and 132 disposed on the body 110. The body 110 may include a dielectric layer 111 and internal electrodes 121 and 122. The dielectric layer 111 may include a core-shell grain 10 having a structure of a core 11 and a shell 12 surrounding at least a portion of the core 11. The dielectric layer 111 may include a rare-earth element. A central region of the core 11 is referred to as a first core 11a, and a region surrounding at least a portion of the first core 11a is referred to as a second core 11b. Maximum strain ratios of crystal lattice a-axis lattice constants of the second core 11b in both Eaa directions, with respect to crystal lattice a-axis lattice constants in the central region of the first core 11a, are defined as ba1 and ba2, respectively. Maximum strain ratios of crystal lattice c-axis lattice constants of the second core 11b in both Ecc directions, with respect to crystal lattice c-axis lattice constants in the central region of the first core 11a, are defined as bc1 and bc2, respectively. At least three of the ba1, ba2, bc1 and bc2 values may satisfy +0.5% or greater and +1.5% or less.

In addition, a dielectric composition according to another embodiment of the present disclosure may include a core-shell grain 10 having a core 11 and a shell 12 structure surrounding at least a portion of the core 11. The dielectric composition may also include a rare-earth element. A central region of the core 11 is referred to the first core 11a, and a region surrounding at least a portion of the first core 11a is referred to as a second core 11b. Maximum strain ratios of crystal lattice a-axis lattice constants of the second core 11b in both Eaa directions, with respect to crystal lattice a-axis lattice constants of the first core 11a in the central region are defined as ba1 and ba2, respectively. Maximum strain ratios of crystal lattice c-axis lattice constants of the second core 11b in both Ecc directions, with respect to crystal lattice c-axis lattice constants of the first core 11a in the central region are defined as bc1 and bc2, respectively. At least three of the ba1, ba2, bc1 and bc2 values may satisfy +0.5% or greater and +1.5% or less.

The body 110 may have a dielectric layer 111 and internal electrodes 121 and 122 alternately stacked. More specifically, the body 110 may include a capacitance formation portion Ac forming capacitance, including a first internal electrode 121 and a second internal electrode 122 that are disposed alternately to oppose each other with a dielectric layer 111 interposed therebetween, the electrodes being disposed inside the body 110.

There is no particular limitation on the specific shape of the body 110, but as illustrated, the body 110 may have a hexahedral shape or a shape similar thereto. Due to shrinkage of the ceramic particles included in the body 110 during a sintering process, the body 110 may not have a hexahedral shape with entirely straight lines but may have a substantially hexahedral shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

A plurality of dielectric layers 111 forming the body 110 are in a sintered state, such that boundaries between adjacent dielectric layers 111 may be integrated so as to be difficult to identify without using a scanning electron microscope (SEM).

The raw material forming the dielectric layer 111 is not limited as long as sufficient electrostatic capacitance can be obtained therewith. In general, perovskite ABO₃-based materials may be used, for example, barium titanate-based materials, lead composite perovskite-based materials, or strontium titanate-based materials may be used. The barium titanate-based material may include BaTiO₃-based ceramic particles, and examples of the ceramic particles include BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1), in which calcium Ca, zirconium Zr, or the like are partially dissolved.

In addition, the raw material for forming the dielectric layer 111 may be particles such as barium titanate BaTiO₃, to which various ceramic additives, organic solvents, binders, dispersants, or the like, may be added according to the purpose of the present disclosure.

In addition, the dielectric layer 111 may include the dielectric composition described in the present disclosure, and any overlapping description will be omitted. The dielectric composition may be, but is not particularly limited to, the content of the dielectric microstructure.

The dielectric layer 111 or dielectric composition may include core-shell grains 10 having the core 11 and the shell 12. The shell 12 may be structure surrounding at least a portion of the core 11 and including the rare-earth element. However, the present disclosure is not limited thereto and may include grains that do not have a core-shell structure.

A size of the core-shell grains 10 may be 150 nm or greater and 300 nm or less.

The size of the core-shell grains 10 may be obtained through a built-in program after observing the grains in equipment such as SEM (HRSEM), TEM (HRTEM), and STEM (HRSTEM) described later, but is not particularly limited thereto.

When the size of the core-shell grains 10 is 150 nm or greater and 300 nm or less, the dielectric characteristics may be enhanced, and the reliability may be enhanced.

If the size of the core-shell grains 10 is less than 150 nm, there is a concern that the target dielectric characteristics may not be achieved, and if the size of the core-shell grains 10 is more than 300 nm, there is a concern that reliability thereof may not be enhanced due to insufficient grain boundary area.

When the contents of rare-earth elements are measured using energy dispersive X-ray spectroscopy (EDS) mode or the like, a region where the content of rare-earth elements is 0.1 at % or greater may be referred to as the shell 12, and a region where the content of rare-earth elements is less than 0.1 at % may be referred to as the core 11, but this is not particularly limited, and a region where the content of rare-earth elements is relatively high may be referred to as the shell 12.

Here, the rare-earth element may include at least one of lanthanum (La), samarium (Sm), gadolinium (Gd), dysprosium (Dy), holmium (Ho), erbium (Er), cerium (Ce) and ytterbium (Yb), preferably lanthanum (La), more preferably lanthanum (La), but is not particularly limited thereto.

As an example of a more specific method for measuring the content of elements included in each component of the multilayer electronic component 100 in the present disclosure, the components may be analyzed using a scanning electron microscope (SEM) or a high resolution scanning electron microscope (HRSEM), a transmission electron microscope (TEM) or a high resolution transmission electron microscope (HRTEM), an EDS mode of a scanning transmission electron microscope (STEM) or a high resolution scanning transmission electron microscope (HRTEM). First, a thinned sample for analysis is prepared using a focused ion beam (FIB) device in a region to be measured. Then, a damaged layer on a surface of the thinned sample is removed using xenon (Xe) or argon (Ar) ion milling, and then each component to be measured is mapped from an image obtained using EDS analysis to conduct qualitative/quantitative analysis. In this case, the qualitative/quantitative analysis graph of each component may be expressed by converting the content of each element, for example, mass percentage (wt %), atomic percentage (at %), or mole percentage (mol %), and may also be expressed by converting the content of a specific component to the content of another specific component.

Another method is to crush the chip to select a region to be measured and then analyze the specific components of a region including the selected dielectric microstructure using a device such as an inductively coupled plasma optical spectroscopy (ICP-OES) or an inductively coupled plasma mass spectrometer (ICP-MS).

The central region of the core 11 may be referred to as the first core 11a, and the region surrounding at least a portion of the first core 11a may be referred to as the second core 11b. Here, the second core 11b may mean a region between the first core 11a and the shell 12, and more specifically, for example, the second core 11b may mean a region of up to 25% in the direction inside the core 11 from a boundary surface of the core 11 and the shell 12.

More specifically with reference to FIG. 4, based on the straight lines passing through the first core 11a and the second core 11b, regions of the second core 11b disposed with the first core 11a interposed therebetween may be referred to as a 2-1 core and a 2-2 core. In this case, a ratio (Lc2a/Lc) of a length Lc2a of the 2-1 core to a length Lc of the core 11 and a ratio (Lc2b/Lc) of a length of Lc2b of the 2-2 core to the length Lc of the core 11 may satisfy Lc2a/Lc≤0.25 and Lc2b/Lc≤0.25.

In addition, a ratio (Lc2/Lc) of a length Lc2 of the second core 11b to the length Lc of the core 11 may satisfy Lc2/Lc≤0.5, where the length Lc2 of the second core may mean a sum of the length Lc2a of the 2-1 core and the length Lc2b of the 2-2 core.

When the maximum strains of the crystal lattice a-axis lattice constants of the second core 11b in both Eaa directions, with respect to the crystal lattice a-axis lattice constants in the central region of the first core 11a are defined as ba1 and ba2, respectively, and the maximum strains of the crystal lattice c-axis lattice constants of the second core 11b in both Ecc directions, with respect to the crystal lattice c-axis lattice constants of the first core 11a in the central region are defined as bc1 and bc2, respectively, at least three values among ba1, ba2, bc1 and bc2 may satisfy +0.5% or greater and +1.5% or less.

The method for observing the deformation of the crystal lattice within the core-shell grains 10 may be as follows but is not particularly limited thereto. First, the dielectric layer 111 is observed in the cross-section of the body 110 in the length and thickness directions using a high-resolution transmission electron microscope (HRTEM). In this case, it is possible to observe core-shell grains 10 in which the core 11 and shell 12 are distinguished due to deformation, but if the distinction is not clear, the core-shell grains 10 are selected after mapping rare-earth elements (e.g., lanthanum (La)) in EDS analysis mode. Strain mapping is performed on the selected core-shell grains 10 using the GPA (Geometric Phase Analysis) method. The GPA analysis method may calculate strain for each lattice direction from HRTEM images including lattice information. In strain mapping, the strain occurring in the a-axis direction of the crystal lattice, which is the Eaa direction, is measured, and the strain occurring in the c-axis direction of the crystal lattice, which is the Ecc direction, is measured. In this case, when measuring deformation in the Eaa direction, a line profile is performed so as to pass through the center region of the first core 11a to observe the deformation of the corresponding sections, and when measuring deformation in the Ecc direction, a line profile is performed so as to pass through the center region of the first core 11a to observe the deformation of the corresponding sections. In this case, a degree of deformation of the corresponding sections where line-profile was performed in the Eaa direction and Ecc direction may be confirmed in a graph. Here, the degree of deformation may correspond to the strain rate (%) based on the central region of the first core 11a (strain value 0%). In other words, the degree of deformation in the Eaa direction may correspond to a strain ratio ({(a−a0)/a0}%) of the crystal lattice a-axis lattice constant (a) in a measurement region relative to a crystal lattice a-axis lattice constant (a0) in the central region of the first core 11a, and the degree of deformation in the Ecc direction may correspond to a strain ratio ({(c−c0)/c0}%) of a crystal lattice c-axis lattice constant (c) in a measurement region relative to a crystal lattice c-axis lattice constant (c0) in the central region of the first core 11a.

In this case, the maximum strains in the Eaa direction in the second core 11b region may be referred to as ba1 and ba2, respectively, and the maximum strains in the Ecc direction may be referred to as bc1 and bc2, respectively.

More specifically with reference to FIG. 4, when a line profile is performed in the Eaa direction, the maximum strain in the a1 region among the regions of the second core 11b may be referred to as ba1, and the maximum strain in the a2 region may be referred to as ba2, and when line-profile is performed in the Ecc direction, the maximum strain in the c1 region of the second core 11b may be referred to as bc1, and the maximum strain in the c2 region may be referred to as bc2.

In other words, in the present disclosure, preferably, the maximum lattice constant strain in the Eaa direction within a region of up to 25% in the direction inside the core 11 from the boundary surface of the core 11 and the shell 12, which is the second core 11b region, may be referred to as ba1 and ba2, and the maximum lattice constant strain in the Ecc direction may be referred to as bc1 and bc2, and in this case, at least three values among ba1, ba2, bc1, and bc2 may satisfy +0.5% or greater and +1.5% or less.

One factor that may increase the permittivity of a dielectric material is stress control within the core-shell grain 10. When compressive stress is applied within the core 11, the dielectric properties may be degraded, whereas when tensile stress is applied within the core 11, the dielectric properties may be improved. However, when excessive tensile stress is applied within the core, there is a risk that the dielectric characteristics may deteriorate due to distortion of the crystal lattice, so a design of the base material that may apply appropriate tensile stress within the core may be required.

Accordingly, the present disclosure may improve dielectric characteristics by controlling the tensile stress inside the core-shell crystal grains 10, and specifically, may improve dielectric characteristics by controlling the tensile stress inside the core 11, more specifically, inside the second core 11b. The tensile stress inside the core 11 may vary depending on the presence or absence of rare-earth elements included in the shell 12 or the amount of addition, and may also vary depending on process conditions, or the like.

That is, when at least three values among ba1, ba2, bc1, and bc2 satisfy +0.5% or greater +1.5% or less, the dielectric characteristics may be improved while the reliability can be improved.

Here, if the maximum strain is positive (+), it may mean tensile strain, and if it is negative (−), it may mean compressive strain.

If at least three of the values of ba1, ba2, bc1, and bc2 do not satisfy +0.5% or greater +1.5% or less, there may be a concern that the dielectric characteristics will not be improved. For example, when there are two or more values of ba1, ba2, bc1 and bc2 whose maximum strain is less than +0.5%, the effect of improving the dielectric characteristics by tensile strain may be minimal, when two or more values of ba1, ba2, bc1 and bc2 have a maximum strain exceeding +1.5%, line defects, such as dislocations, may occur due to excessive tensile strain, this may result in minimal improvement in dielectric characteristics as dislocations relieve the tensile stress applied within the core-shell grains.

That is, the core-shell grain 10 may not contain line defects such as dislocations, and the core-shell grain 10 here may mean that tensile stress is applied internally.

Hereinafter, a method for measuring the maximum strain will be described in more detail using as examples FIGS. 5A to 5E, which are Example 1 having enhanced dielectric characteristics, and FIGS. 6A to 6E, which are Comparative Example 1 having poor dielectric characteristics.

[Table 1] below describes the maximum strain in the Eaa direction and the Ecc direction for the five core-shell grains included in Example 1 and Comparative Example 1, and the dielectric constants of Example 1 and Comparative Example 1. Example 1 and Comparative Example 1 correspond to the first grains of Example and Comparative Example, respectively.

FIG. 5A is a high-resolution transmission electron microscope (HRTEM) image of the core-shell grains of Example 1, FIG. 5B is a strain mapping image of FIG. 5A in the Eaa direction, FIG. 5C is a strain mapping image of FIG. 5A in the Ecc direction, FIG. 5D illustrates a regional strain graph of FIG. 5B, and FIG. 5E illustrates a regional strain graph of FIG. 5C.

FIG. 6A is an image of the core-shell grains of Comparative Example 1 observed using a high-resolution transmission electron microscope (HRTEM), FIG. 6B is a strain mapping image of FIG. 6A in the Eaa direction, FIG. 6C is a strain mapping image of FIG. 6A in the Ecc direction, FIG. 6D illustrates a strain graph by region of FIG. 6B, and FIG. 6E illustrates a strain graph by region of FIG. 6C.

When analyzing FIG. 5D and FIG. 5E, it may be confirmed that there are three or more values in which the maximum strain (%) corresponding to the peak is +0.5% or greater and +1.5% or less in a region within 25% from the boundary of the core 11 and the shell 12. On the other hand, when analyzing FIGS. 6D and 6E, it may be confirmed that there are less than three values in which the maximum strain (%) corresponding to the peak is greater than +0.5% and less than +1.5% in a region within 25% from the boundary of the core 11 and the shell 12.

TABLE 1

| | Maximum strain (%) | | | | | | | |
|---|---|---|---|---|---|---|---|---|
| | Example 1 | | | | Comparative Example 1 | | | |
| | ba1 | ba2 | bc1 | bc2 | ba1 | ba2 | bc1 | bc2 |
| First grain | +0.68 | +0.67 | +0.63 | +1.49 | +0.51 | +0.11 | +1.41 | +0.46 |
| Second grain | +0.79 | +0.62 | +0.57 | +1.26 | +0.49 | +0.23 | +1.00 | +0.02 |
| Third grain | +0.78 | +0.59 | +0.58 | +1.13 | +0.27 | +0.10 | +0.70 | +0.93 |
| Fourth grain | +0.74 | +0.54 | +0.64 | +1.49 | +0.39 | +0.21 | +0.97 | +0.27 |
| Fifth grain | +0.73 | +0.44 | +0.62 | +1.04 | +1.80 | +0.31 | +1.16 | −0.03 |
| Dielectric | 18.88 | | | | 16.39 | | | |
| Constant | | | | | | | | |

Meanwhile, the lattice constant ratio (c/a) of the core 11 may satisfy 1.015≤c/a, which may represent the average lattice constant ratio (c/a) of the core 11.

When the lattice constant ratio (c/a) of the core 11 satisfies 1.015 or greater, the tetragonality of the lattice structure may be enhanced, so that the dielectric characteristics may be further improved. When the lattice constant (c/a) of the core 11 is less than 1.015, the effect of improving the dielectric characteristics may be minimal.

This may be due to improved dielectric characteristics by uniformly improving tetragonality throughout the core 11 region as at least three of the values of ba1, ba2, bc1 and bc2 in the second core 11b may satisfy +0.5% or greater +1.5% or less but is not particularly limited thereto.

Methods for measuring the lattice constant ratio (c/a) may include, but are not limited to, the following. After observing the core-shell grains 10 in a high-resolution transmission electron microscope (HRTEM), a frequency peak due to periodic lattice deformation may be observed from the frequency components obtained by performing a fast Fourier transform (FFT) on the core 11, and from this, the lattice vectors of the a-axis and c-axis may be determined, and then the lattice constant ratio (c/a) may be calculated.

Hereinafter, FIGS. 7A to 7C, which are Example 2 having excellent dielectric characteristics, and FIGS. 7D to 7F, which are Comparative Example 2 having poor dielectric characteristics, will be described in more detail. In this case, in Example 2, at least three values among the maximum strain rates ba1, ba2, bc1, and bc2 in the second core 11b satisfy a range of +0.5% or greater and +1.5% or less, and Comparative Example 2, at least three values among the maximum strain rates ba1, ba2, bc1, and bc2 in the second core 11b do not satisfy a range of +0.5% or greater and +1.5% or less.

FIG. 7A is an image of the core-shell grains of the example observed using a high-resolution transmission electron microscope (HRTEM), FIG. 7B is a fast Fourier transform (FFT) performed on FIG. 7A, and FIG. 7C is a graph illustrating the lattice constant ratio (c/a) according to the analysis of FIG. 7B. FIG. 7D is an image of the core-shell grains of a comparative example observed using a high-resolution transmission electron microscope (HRTEM), FIG. 7E is a fast Fourier transform (FFT) performed on FIG. 7D, and FIG. 7F is a graph illustrating the lattice constant ratio (c/a) according to the analysis of FIG. 7E.

The core lattice constant ratio (c/a) of Example 2 was calculated as 1.0152, and the core lattice constant ratio (c/a) of Comparative Example 2 was calculated as 1.0074.

This illustrates that the lattice constant ratio (c/a) of Example 2 is increased compared to Comparative Example 2, and the dielectric characteristics are improved as at least three of the maximum strains ba1, ba2, bc1 and bc2 in the second core 11b, satisfy a range of +0.5% or greater and +1.5% or less.

Meanwhile, in order to distinguish the dielectric layer 111 from the dielectric layer included in cover portions 112 and 113 and/or side margin portions 114 and 115 to be described later, the dielectric layer 111 included in the capacitance formation portion Ac may be defined as a first dielectric layer, the dielectric layer included in the cover portions 112 and 113 may be defined as a second dielectric layer, and the dielectric layer included in the side margin portions 114 and 115 may be defined as a third dielectric layer.

In addition, since the first to third dielectric layers may be formed using a dielectric material such as barium titanate BaTiO₃, they may include a dielectric microstructure after sintering. The dielectric microstructure may include a plurality of grains, grain boundaries disposed between adjacent grains, and triple points disposed at points where three or more grain boundaries meet, and may each include a plurality of grains, grain boundaries, and triple points.

A thickness td of the dielectric layer 111 is not particularly limited.

However, in order to more easily achieve miniaturization and high capacitance of the multilayer electronic component, the thickness td of the dielectric layer 111 may be 1.0 μm or less, 0.8 μm or less, or 0.6 μm or less, and in order to achieve ultra-miniaturization, it may be 0.5 μm or less, or 0.4 μm or less.

Here, the thickness td of the dielectric layer 111 may mean the thickness td of the dielectric layer 111 disposed between the first and second internal electrodes 121 and 122.

In this case, the thickness td of the dielectric layer 111 may be a concept including the thickness td of any one of a plurality of dielectric layers 111 or may be a concept including the thickness td of each of all dielectric layers 111.

In addition, the thickness td of the dielectric layer 111 may mean the average thickness td of one dielectric layer 111, may mean an average thickness td of each of the plurality of dielectric layers 111, or may mean the average thickness td of the plurality of dielectric layers 111.

The average thickness td of the dielectric layer 111 may be measured by scanning an image of a cross-section in the length and thickness direction of the body 110 using a field emission scanning electron microscope (SEM) at 10,000× magnification. More specifically, the average thickness td of one dielectric layer 111 may mean an average value calculated by measuring the thickness of one dielectric layer 111 at 5 points equally spaced apart in the longitudinal direction in a scanned image. The 5 points equally spaced apart from each other may be designated in the capacitance formation portion Ac. In addition, by extending this average value measurement to 3 dielectric layers 111 and calculate the average value, the average thickness td of the plurality of dielectric layers 111 may be further generalized.

The internal electrodes 121 and 122 may be alternately stacked with the dielectric layer 111.

The internal electrodes 121 and 122 may include a first internal electrode 121 and a second internal electrode 122, and the first and second internal electrodes 121 and 122 may be alternately disposed to face each other with the dielectric layer 111 constituting the body 110 interposed therebetween. The internal electrodes 121 and 122 may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body 110 and connected to the first internal electrode 121, and a second external electrode 132 may be disposed on the fourth surface 4 of the body 110 and connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. At this time, the first and second internal electrodes 121 and 122 may be electrically separated from each other by a dielectric layer 111 disposed in the middle.

Meanwhile, the body 110 may be formed by alternately stacking a first ceramic green sheet printed with a paste for a first internal electrode, which may be become the first internal electrode 121, and a second ceramic green sheet printed with a paste for a second internal electrode, which will become the second internal electrode 122, and then firing the stacked. The printing method of the conductive paste for the internal electrode may use a screen-printing method or a gravure printing method, but the present disclosure is not limited thereto.

The material forming the internal electrodes 121 and 122 is not particularly limited, and a material with excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti) and alloys thereof. Meanwhile, the thickness the of the internal electrodes 121 and 122 do not need to be particularly limited, and the description of the thickness the of the internal electrodes 121 and 122 below may mean the thickness the of each of the first internal electrode 121 and the second internal electrode 122.

In order to achieve miniaturization and high capacitance of the multilayer electronic component 100, the thickness (the) of the internal electrodes 121 and 122 may be 1.0 μm or less, 0.8 μm or less, or 0.6 μm or less, and in order to achieve ultra-miniaturization, it may be 0.5 μm or less, or 0.4 μm or less.

In this case, the thickness the of the internal electrodes 121 and 122 may be a concept including the thickness the of at least one of the multiple internal electrodes 121 and 122, or may be a concept including the thickness the of all internal electrodes 121 and 122.

In this case, the thickness the of the internal electrodes 121 and 122 may be a concept including the thickness the of at least one of the plurality of internal electrodes 121 and 122, or may be a concept including the thickness the of all internal electrodes 121 and 122, respectively

In addition, the thickness the of the internal electrodes 121 and 122 may mean an average thickness the of one internal electrodes 121 and 122 or may mean an average thickness the of each of the plurality of internal electrodes 121 and 122, or may mean an average thickness the of the plurality of internal electrodes 121 and 122.

The average thickness the of the internal electrodes 121 and 122 may be measured by scanning the cross-section of the body (110) in the length and thickness directions with a scanning electron microscope (SEM) at 10,000× magnification. More specifically, the average thickness (the) of one inner electrodes 121 and 122 may be an average value calculated by measuring the thickness of one internal electrode at 5 points equally spaced apart in the longitudinal direction in the scanned image. The 5 points equally spaced apart may be designated in the capacitance formation portion Ac. In addition, extending this average value measurement to 3 internal electrodes 121 and 122, and measuring the average value, the average thickness the of the plurality of internal electrodes 121 and 122 may be further generalized.

Meanwhile, the body 110 may include cover portions 112 and 113 disposed on both end-surfaces of the capacitance formation portion Ac in the thickness direction.

Specifically, the body 110 may include a first cover portion 112 disposed on one surface of the capacitance formation portion Ac in the thickness direction and a second cover portion 113 disposed on the other surface of the capacitance formation portion Ac in the thickness direction. More specifically, for example, the body 110 may include the first cover portion 112 disposed on a lower portion of the capacitance formation portion Ac in the thickness direction and a second cover portion 113 disposed on an upper portion of the capacitance formation portion Ac in the thickness direction.

The first cover portion 112 and the second cover portion 113 may be formed by disposing or stacking a single second dielectric layer or two or more second dielectric layers on the upper and lower surfaces of the capacitance formation portion Ac in the thickness direction, respectively, and may prevent damage to the internal electrodes 121 and 122 due to physical or chemical stress.

The first cover portion 112 and the second cover portion 113 may not include internal electrodes 121 and 122 and may include the same dielectric material as the first dielectric layer 111 of the capacitance formation portion Ac. That is, the first cover portion 112 and the second cover portion 113 may include a dielectric material, for example, a barium titanate (BaTiO₃)-based dielectric material.

Meanwhile, the thickness tc of the cover portions 112 and 113 may not need to be particularly limited, and a description of the thickness tc of the cover portions 112 and 113 may mean the thickness tc of each of the first cover portion 112 and the second cover portion 113.

However, in order to easily implement miniaturization and high capacitance of the multilayer electronic component 100, the thickness tc of the cover portions 112 and 113 may be 100 μm or less or 50 μm or less, preferably 30 μm or less, and more preferably 20 μm or less in ultra-small products.

Here, the thickness tc of the cover portions 112 and 113 may mean the average thickness of the cover portions 112 and 113.

Additionally, the average thickness tc of the cover portions 112 and 113 may mean the average thickness tc of each of the first and second cover portions 112 and 113 or may mean the average thickness tc of the first and second cover portions 112 and 113.

The average thickness tc of the cover portions 112 and 113 may be measured by scanning an image of a cross-section of the body 110 in the length and thickness direction using a scanning electron microscope (SEM) at 10,000× magnification. More specifically, it may mean an average value calculated by measuring the thickness at 5 points equally spaced apart in the longitudinal direction in an image scanned of one cover portions 112 and 113.

In addition, the average thickness tc of the cover portions 112 and 113 measured by the above-described method may have a value substantially the same as the average thickness of the cover portions 112 and 113 in the cross-section of the body 110 in the width and thickness direction.

Meanwhile, the multilayer electronic component 100 may include a side margin portions 114 and 115, which is a width-wise end region of the internal electrodes 121 and 122

The side margin portions 114 and 115 may basically contribute to prevent damage to the internal electrodes 121 and 122 due to physical or chemical stress.

More specifically, the side margin portions 114 and 115 may include a first side margin portion 114 disposed between the internal electrodes 121 and 122 and the fifth surface 5 and a second side margin portion 115 disposed between the internal electrodes 121 and 122 and the sixth surface 6.

As illustrated, the side margin portions 114 and 115 may refer to a region between the width-wise ends of the first and second internal electrodes 121 and 122 and the boundary surface of the body 110, based on the cross-section of the body 110 in the width and thickness directions.

The side margin portions 114 and 115 may refer to a ceramic green sheet region excluding the internal electrodes 121 and 122 when the internal electrode paste is applied onto the ceramic green sheet for the capacitance formation portion Ac, excluding regions corresponding to the side margin portions 114 and 115.

That is, the side margin portions 114 and 115 may not include the internal electrodes 121 and 122 and may include the same material as the first dielectric layer 111, and may correspond to, for example, a portion of the first dielectric layer 111. In other words, the first side margin portion 114 and the second side margin portion 115 may include a dielectric material, for example, a barium titanate (BaTiO₃)-based dielectric material.

However, it is not particularly limited thereto, and the side margin portions 114 and 115 may be formed by applying a conductive paste to the ceramic green sheet applied to the capacitance formation portion Ac, other than the region in which the side margin portions 114 and 115 may be formed, thereby forming internal electrodes 121 and 122, and in order to suppress a step difference caused by the internal electrodes 121 and 122, the body 110 may be cut so that the internal electrodes 121 and 122 after stacking to be exposed to the fifth and sixth surfaces 5 and 6 of the body 110, and then a single third dielectric layer or two or more third dielectric layers may be formed by disposing or stacking them on both end-surfaces of the capacitance formation portion Ac in the width direction.

Meanwhile, a width wm of the side margin portions 114 and 115 may not need to be particularly limited, and the description of the width wm of the side margin portions 114 and 115 may mean a width wm of the first side margin portion 114 and the second side margin portion 115, respectively.

In order to easily implement miniaturization and high capacitance of the multilayer electronic component 100, the width wm of the side margin portions 114 and 115 may be 50 μm or less, preferably 30 μm or less, and may be more preferably 20 μm or less in ultra-small products.

Here, the width wm of the side margin portions 114 and 115 may mean an average width wm of the side margin portions 114 and 115.

Additionally, the average width wm of the side margin portions 114 and 115 may mean the average width wm of each of the first and second side margin portions 114 and 115, or may mean an average width wm of the first and second side margin portions 114, 115.

The average width wm of the side margin portions 114 and 115 may be measured by scanning an image of a cross-section of the body 110 in the width and thickness direction using a scanning electron microscope (SEM) at 10,000× magnification. More specifically, it may mean an average value calculated by measuring the width at 5 points equally spaced apart in the thickness direction in an image scanned of one side margin portions 114 and 115.

In an embodiment of the present disclosure, a structure in which the multilayer electronic component 100 may have two external electrodes 131 and 132 is described, but the number or shape of the external electrodes 131 and 132 may be varied depending on the form of the internal electrodes 121 and 122 or other purposes.

The external electrodes 131 and 132 may be disposed on the body 110 and may be connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Additionally, the external electrodes 131 and 132 may extend and be disposed on portions of the first and second surfaces 1 and 2 of the body 110 or may extend and be disposed on portions of the fifth and sixth surfaces 5 and 6 of the body 110. That is, the first external electrode 131 may be disposed on the third surface 3 of the body 110 and a portion of the first, second, fifth, and sixth surfaces 1, 2, 5, and 6 of the body 110, and the second external electrode 132 may be disposed on the fourth surface 4 of the body 110 and a portion of the first, second, fifth, and sixth surfaces 1, 2, 5, and 6 of the body 110.

The external electrodes 131 and 132 may be formed of any material having electrical conductivity, such as metal, and a specific material may be determined by consideration of electrical characteristics and structural stability, or the like, and furthermore, may have a multilayer structure.

For example, the external electrodes 131 and 132 may include a first electrode layers 131a and 132a disposed on the body 110, a second electrode layers 131b and 132b disposed on the first electrode layers 131a and 132a, and a third electrode layers 131c and 132c disposed on the second electrode layers 131b and 132b.

Here, it may be desirable for the first to third electrode layers 131a, 132a, 131b, 132b, 131c and 132c correspond to distinct layers. However, the present disclosure is not limited thereto and may be distinguished according to the order of the manufacturing process, and adjacent layers among the first to third electrode layers 131a, 132a, 131b, 132b, 131c and 132c may not be distinguished from each other and may be observed as one layer.

In the present disclosure, the term “distinguished” may mean that two layers are distinguished due to physical differences, chemical differences, and/or simple optical differences, and is not particularly limited thereto, but the distinction between layers may be identified by the presence or absence of an “interface.” The term “interface” may mean a surface where two layers in contact with each other are distinguishable from each other and may mean a state where they can be distinguished by differences in components, such as through EDS analysis using equipment such as a scanning electron microscope (SEM).

The first electrode layers 131a and 132a may be formed by transferring a sheet including a conductive metal onto the body 110, or may be formed by applying a conductive paste for an external electrode including a conductive metal to the body 110 and then performing sintering, or may be formed by dipping the body 110 into a conductive paste for an external electrode including a conductive metal, but is not particularly limited thereto.

As a more specific example of the first electrode layers 131a and 132a, the first electrode layers 131a and 132a may be a sintered electrode including a conductive metal and glass.

A material having excellent electrical conductivity may be used as the conductive metal included in the first electrode layers 131a and 132a. For example, the conductive metal may include one or more selected from the group consisting of nickel (Ni), copper (Cu), palladium (Pd), silver (Ag), gold (Au), platinum (Pt), tin (Sn), tungsten (W), titanium (Ti) and alloys thereof, but is not particularly limited thereto.

Additionally, the glass included in the first electrode layers 131a and 132a may contribute to prevent bonding with the body 110.

The second and third electrode layers 131b, 132b, 131c and 132c may contribute to improve the mounting characteristics and may be a plating layer formed on the first electrode layers 131a and 132a by plating, but are not particularly limited thereto.

The types of the second and third electrode layers 131b, 132b, 131c and 132c are not particularly limited, and may include, for example, at least one of nickel (Ni), tin (Sn), silver (Ag), palladium (Pd), and alloys thereof.

More specifically, for example, the second and third electrode layers 131b, 132b, 131c and 132c may each be one of a nickel (Ni) electrode layer and a tin (Sn) electrode layer. More specifically, it may be a form of a nickel (Ni) electrode layer and a tin (Sn) electrode layer sequentially formed on the first electrode layers 131a and 132a, or may be in the form of a tin (Sn) electrode layer, a nickel (Ni) electrode layer, and a tin (Sn) electrode layer sequentially formed.

There is no need to specifically limit the size of the multilayer electronic component 100.

However, in order to achieve miniaturization and high capacitance at the same time, the thickness of the dielectric layer and internal electrodes must be reduced to increase the number of layers, so the effect according to the present disclosure may be more noticeable in a multilayer electronic component 100 having a size of 2012 (length×width: 2.0 mm×1.2 mm, length and width satisfy an error of +10%) or less.

Although the embodiments or test examples of the present disclosure have been described in detail above, the present disclosure is not limited by the above-described embodiments and the accompanying drawings and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment and are not intended to limit the disclosure. In this case, singular expressions include plural expressions unless the context clearly indicates otherwise.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including a dielectric layer and internal electrodes; and
an external electrode disposed on the body,
wherein the dielectric layer includes core-shell grains having a core and a shell surrounding at least a portion of the core, the shell including a rare-earth element,
wherein a central region of the core is referred to as a first core, and a region surrounding at least a portion of the first core is referred to as a second core,
wherein maximum strains of crystal lattice a-axis lattice constants of the second core in both Eaa directions, with respect to crystal lattice a-axis lattice constants in the central region of the first core, are defined as ba1 and ba2, respectively,
wherein maximum strains of crystal lattice c-axis lattice constants of the second core in both Ecc directions, with respect to crystal lattice c-axis lattice constants in the central region of the first core, are defined as bc1 and bc2, respectively, and
wherein at least three of the ba1, ba2, bc1 and bc2 values satisfy +0.5% or greater +1.5% or less.

2. The multilayer electronic component of claim 1, wherein a ratio (Lc2/Lc) of a length Lc2 of the second core to a length Lc of the core satisfies Lc2/Lc≤0.5.

3. The multilayer electronic component of claim 1, when a region of the second core disposed with the first core in between is referred to as a 2-1 core and a 2-2 core based on a straight line passing through the first and second cores,
a ratio (Lc2a/Lc) of a length Lc2a of the 2-1 core to a length Lc of the core and a ratio (Lc2b/Lc) of a length Lc2b of the 2-2 core to a length Lc of the core satisfy Lc2a/Lc≤0.25 and Lc2b/Lc≤0.25.

4. The multilayer electronic component of claim 1, wherein the rare-earth element includes at least one of lanthanum (La), samarium (Sm), gadolinium (Gd), dysprosium (Dy), holmium (Ho), erbium (Er), cerium (Ce), and ytterbium (Yb).

5. The multilayer electronic component of claim 1, wherein the core-shell grains do not contain dislocations.

6. The multilayer electronic component of claim 1, wherein a lattice constant ratio (c/a) of the core satisfies 1.015≤c/a.

7. The multilayer electronic component of claim 1, wherein the dielectric layer contains a barium titanate (BaTiO₃)-based material.

8. A dielectric composition, comprising:
a core-shell grain having a core and a shell surrounding at least a portion of the core, the shell including a rare-earth element,
wherein a central region of the core is referred to as a first core, and a region surrounding at least a portion of the first core is referred to as a second core,
wherein maximum strains of crystal lattice a-axis lattice constants of the second core in both Eaa directions, with respect to crystal lattice a-axis lattice constants in the central region of the first core, are defined as ba1 and ba2, respectively,
wherein maximum strains of the crystal lattice c-axis lattice constants of the second core in both Ecc directions, with respect to the crystal lattice c-axis lattice constants in the central region of the first core, are defined as bc1 and bc2, respectively, and
wherein at least three of the ba1, ba2, bc1 and bc2 values satisfy +0.5% or more +1.5% or less.

9. The dielectric composition of claim 8, wherein a ratio (Lc2/Lc) of a length Lc2 of the second core to a length Lc of the core satisfies Lc2/Lc≤0.5.

10. The dielectric composition of claim 8, wherein a region of the second core disposed with the first core in between is defined as a 2-1 core and a 2-2 core based on a straight line passing through the first and second cores,
wherein a ratio (Lc2a/Lc) of a length Lc2a of the 2-1 core to a length Lc of the core and a ratio (Lc2b/Lc) of a length Lc2b of the 2-2 core to a length Lc of the core satisfy Lc2a/Lc≤0.25 and Lc2b/Lc≤0.25.

11. The dielectric composition of claim 8, wherein the rare-earth element includes at least one of lanthanum (La), samarium (Sm), gadolinium (Gd), dysprosium (Dy), holmium (Ho), erbium (Er), cerium (Ce), and ytterbium (Yb).

12. The dielectric composition of claim 8, wherein the core-shell grain does not contain dislocations.

13. The dielectric composition of claim 8, wherein a lattice constant ratio (c/a) of the core satisfies 1.015≤c/a.

14. The dielectric composition of claim 8, wherein the dielectric composition comprises a barium titanate (BaTiO₃)-based material.
